(19) United States
(12) Patent Application Publication
(10) Pub. No.: US 2024/0243470 A1
(43) Pub. Date: Jul. 18, 2024

(54) ANTENNA AND BASE STATION ANTENNA FEEDER SYSTEM

(71) Applicant: HUAWEI TECHNOLOGIES CO., LTD., Shenzhen (CN)

(72) Inventors: Bin CHEN, Dongguan (CN); Zihui LIU, Dongguan (CN); Li ZHANG, Dongguan (CN); He CUI, Dongguan (CN)

(21) Appl. No.: 18/619,556

(22) Filed: Mar. 28, 2024

Related U.S. Application Data
(63) Continuation of application No. PCT/CN2022/121394, filed on Sep. 26, 2022.

(30) Foreign Application Priority Data
Sep. 30, 2021 (CN) 202111168870.6

(51) Int. Cl. H01Q 3/36; H01Q 1/12; H01Q 3/06

(52) U.S. Cl. CPC H01Q 3/36; H01Q 1/1228; H01Q 3/06

(57) ABSTRACT

This application provides an antenna and a base station antenna feeder system. The antenna includes a first phase shifter, where the first phase shifter includes a cavity and a phase-shift circuit. The phase-shift circuit is disposed in the cavity. The cavity is connected to a mounting structure, and the mounting structure is configured to connect to a pole. In this solution, the cavity can support the entire antenna using the cavity of the first phase shifter as a frame of the antenna, and by mounting the cavity of the first phase shifter on the pole with the mounting structure.

### CROSS-REFERENCE TO RELATED APPLICATIONS

This application continuation of International Application No. PCT/CN2022/121394, filed on Sep. 26, 2022, which claims priority to Chinese Patent Application No. 202111168870.6, filed on Sep. 30, 2021. The disclosures of the aforementioned applications are hereby incorporated by reference in their entireties.

### BACKGROUND

With development of wireless communication technologies, a base station supports more communication frequency bands. Therefore, an antenna of the base station accordingly uses more radiation elements and phase shifters, making a structure of the antenna more complex. Because antenna space of an operator site is limited, the radiation elements of the antenna of the base station are disposed in a nested or stacked manner during disposal.

For an antenna of a base station in conventional technologies, radiation elements of the antenna of the base station, phase shifters, and other components are all disposed on a reflection plate, and the reflection plate is fastened to a pole. In this case, the reflection plate bears weights of the various components such as the radiation element and the phase shifter of the antenna. As the reflection plate is of a plate-shaped structure, deformation or cracking is prone to occur in response to the reflection plate being under large force. In response to the reflection plate vibrating due to an external environment or other factors, these problems are worsened. In addition, a joint between the reflection plate and the pole also likely suffers from damage under excessive force. All these problems cause damage to the antenna of the base station, or deteriorate performance of the antenna of the base station.

### SUMMARY

Embodiments described herein provide an antenna and a base station antenna feeder system, to improve stability of a mounting structure of the antenna, so that the antenna is not prone to damage, a service life of the antenna is prolonged, and performance of the antenna of a base station is ensured.

According to a first aspect, at least one embodiment provides an antenna. The antenna includes a first phase shifter, where the first phase shifter includes a cavity and a phase-shift circuit. The phase-shift circuit is disposed in the cavity. The cavity is connected to a mounting structure, and the mounting structure is configured to connect to a pole. In this solution, the cavity supports the entire antenna by using the cavity of the first phase shifter as a frame of the antenna, and by mounting the cavity of the first phase shifter on the pole with the mounting structure. In this solution, the cavity of the first phase shifter is used as a force-bearing framework of the antenna, and the cavity is used to bear a weight of the antenna, to help improve stability of the mounting structure of the antenna, so that the antenna is not prone to damage, a service life of the antenna is prolonged, and performance of the antenna of a base station is ensured.

In a specific technical solution, the antenna further includes a reflection plate, and the reflection plate is connected to the cavity. In this solution, disposing of the reflection plate helps improve a gain of the antenna. In addition, the reflection plate is connected to the cavity, and the cavity is connected to the pole, so that the reflection plate does not transfer the weight of the antenna. Therefore, according to this solution, the reflection plate is less likely to be damaged, operating performance is improved, and a service life of the reflection plate and the antenna is prolonged.

A specific shape of the foregoing cavity is not limited. In a technical solution, the foregoing cavity is strip-like. The reflection plate extends in a first direction and a second direction separately, and the first direction is perpendicular to the second direction. A length of the reflection plate in the first direction is greater than a length of the reflection plate in the second direction. For example, the reflection plate is rectangular. A long edge of the rectangular reflection plate extends in the first direction, and a wide edge extends in the second direction. An extension direction of the strip cavity is consistent with the first direction. Strength of the reflection plate is poorer in a direction in which a length is greater. Therefore, the strip cavity is fastened to the reflection plate in the first direction of the reflection plate, so that the strength of the reflection plate is improved to a large extent.

The reflection plate includes a first side edge and a second side edge that extend in the first direction, and the first side edge and the second side edge are disposed opposite to each other. For example, the reflection plate is rectangular. The first side edge and the second side edge are two long edges of the rectangular reflection plate. The first side edge and the second side edge are separately connected to the strip cavity. In other words, the strip cavity is disposed at an edge of the reflection plate. According to this solution, an operating status of the reflection plate is less affected by the cavity. In addition, the cavity is located at the edge of the reflection plate, to help avoid a radiation signal generated by the antenna and reduce an insertion loss of the antenna, and help improve the gain of the antenna.

A length of the strip cavity in the first direction is equal to the length of the reflection plate in the first direction. The strip cavity in this solution provides comprehensive support for the reflection plate, to improve strength of the frame of the antenna. In addition, a structure of the antenna is normalized.

A quantity of first phase shifters of the antenna is not limited, and is specifically set based on an actual usage. The antenna includes at least two first phase shifters, and the at least two first phase shifters are divided into two groups. In this solution, the two groups of first phase shifters include a same quantity of first phase shifters or different quantities of first phase shifters. This is not limited in at least one embodiment. For example, in response to a quantity of first phase shifters being an even number, the even number of first phase shifters is evenly divided into two groups of first phase shifters. In another embodiment, the two groups of first phase shifters include different quantities of first phase shifters. A cavity in each group of first phase shifters is of an integrated structure. Therefore, each group of first phase shifters is used as a whole to support the antenna, so that strength of a support structure of the antenna is improved, and reliability of the support structure of the antenna is improved.

In response to the antenna including the reflection plate, and the quantity of first phase shifters is the even number, the even number of first phase shifters are symmetrically disposed on the reflection plate. In other words, the even number of first phase shifters are evenly divided into two groups of first phase shifters, and the two groups of first phase shifters are symmetrically disposed on the reflection plate. This solution helps improve symmetry of the structure of the antenna and improve stability of the antenna.

In addition to the foregoing first phase shifter, the antenna further includes a second phase shifter, and the second phase shifter is flatly disposed on a surface of the reflection plate. In this solution, the second phase shifter is flatly disposed, so that less space is occupied in a height direction, to help reduce thickness of the antenna and improve wind load and size competitiveness of the antenna.

The antenna further includes a radiation element, and the radiation element is connected to the cavity. In this technical solution, the radiation element is directly disposed in the cavity, so that the cavity is used to directly bear a weight of the radiation element. In this solution, the radiation element is not disposed on the reflection plate, so that a weight born by the reflection plate is further reduced, thereby reducing the probability of the damage to the reflection plate and improving overall reliability of the antenna. In addition, the radiation element is directly connected to the cavity, so that a connection path is short, a loss of the connection path is reduced, and the gain of the antenna is improved.

In another technical solution, the antenna further includes a radome and a radiation element, and the foregoing first phase shifter and the radiation element are disposed in the radome. The radiation element is connected to the cavity, and an inner wall of the radome has a reflection layer. In this solution, the reflection layer is directly fabricated on the inner wall of the radome, and no reflection plate is to be additionally disposed, so that costs of the antenna are low.

The cavity in the foregoing embodiment is the strip cavity, and a plurality of radiation elements form a linear array antenna system. An extension direction of the strip cavity is consistent with an extension direction of the linear array antenna system. This solution helps reduce a distance between the linear array antenna system and the strip cavity, and shorten a path for connecting the radiation element to the first phase shifter, to reduce an antenna loss.

Specifically, a length of the strip cavity in the extension direction is greater than or equal to a length of the linear array antenna system in the extension direction. In this solution, all radiation elements of the linear array antenna system are disposed in the strip cavity, to reduce the antenna loss and improve antenna integrity.

According to a second aspect, at least one embodiment further provides a base station antenna feeder system. The base station antenna feeder system includes the antenna and the pole in the first aspect, and the mounting structure of the antenna is connected to the pole. In this solution, the cavity of the first phase shifter is used to bear a weight of the antenna, to help improve stability of the mounting structure of the antenna, so that the antenna is not prone to damage, a service life of the antenna is prolonged, and performance of the antenna of a base station is ensured.

### BRIEF DESCRIPTION OF DRAWINGS

FIG. 1 is a schematic diagram of a system architecture to which at least one embodiment is applicable:

FIG. 2 is a schematic diagram of a structure of a base station antenna feeder system according to at least one embodiment:

FIG. 3 is a schematic diagram of composition of an antenna according to at least one embodiment;

FIG. 4 is a side sectional view of an antenna according to at least one embodiment;

FIG. 5 is a top view of an interior of an antenna according to at least one embodiment;

FIG. 6 is a top view of an interior of an antenna according to at least one embodiment;

FIG. 7 is a schematic diagram of a structure of an antenna according to at least one embodiment;

FIG. 8 is a schematic diagram of a structure of an antenna according to at least one embodiment;

FIG. 9 is a schematic diagram of a structure of an antenna according to at least one embodiment;

FIG. 10 is a schematic diagram of a structure of an antenna according to at least one embodiment;

FIG. 11 is a schematic diagram of a structure of an antenna according to at least one embodiment;

FIG. 12 is a schematic diagram of a structure of an interior of an antenna according to at least one embodiment; and

FIG. 13 is a schematic diagram of a structure of an antenna according to at least one embodiment.

### REFERENCE NUMERALS

1—antenna; 11—radome;
12—first radiation element; 12′—second radiation element;
13—reflection plate; 131—first side edge;
132—second side edge; 14—feeder network;
141—drive part; 142—calibration network;
143—phase shifter; 1431—first phase shifter;
1432—second phase shifter; 14311—cavity;
144—combiner; 145—filter;
146—mounting structure; 2—pole;
3—antenna adjustment support; 5—radio frequency processing unit;
6—baseband processing unit; 7—cable.

### DESCRIPTION OF EMBODIMENTS

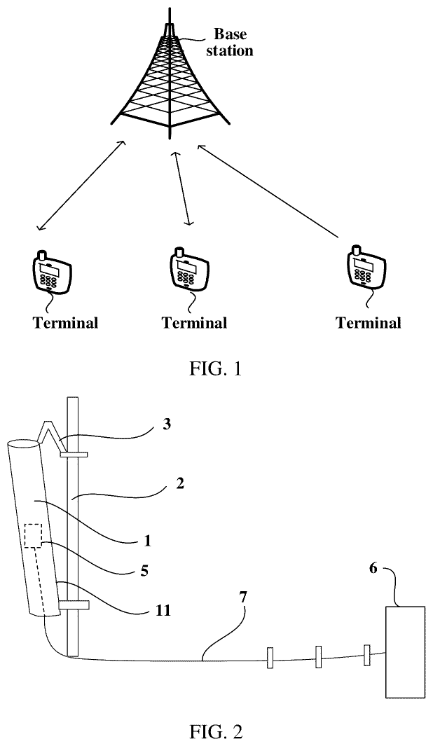

To facilitate understanding of an antenna and a base station antenna feeder system provided in at least one embodiment, the following describes an application scenario thereof. For example, as shown in FIG. 1, the application scenario includes a base station and a terminal. Wireless communication is implemented between the base station and the terminal. The base station is located in a base station subsystem (base station subsystem, BSS), a terrestrial radio access network (UMTS terrestrial radio access network, UTRAN), or an evolved terrestrial radio access network (evolved universal terrestrial radio access network, E-UTRAN), and is configured to implement cell coverage of a radio signal, so as to implement communication between a terminal device and a wireless network. Specifically, the base station is a base transceiver station (base transceiver station, BTS) in a global system for mobile communications (global system for mobile communications, GSM) or a (code division multiple access, CDMA) system, or is a NodeB (NodeB, NB) in a wideband code division multiple access (wideband code division multiple access, WCDMA) system, or is an evolved NodeB (evolved NodeB, eNB or eNodeB) in a long term evolution (long term evolution, LTE) system, or is a radio controller in a cloud radio access network (cloud radio access network, CRAN) scenario. Alternatively, the base station is a relay station, an access point, a vehicle-mounted device, a wearable device, a gNodeB (gNodeB or gNB) in a new radio (new radio, NR) system, a base station in a future evolved network, or the like. This is not limited in at least one embodiment.

FIG. 2 is a schematic diagram of a structure of a base station antenna feeder system. The base station antenna feeder system usually includes an antenna 1, a pole 2, an antenna adjustment support 3, and other structures. The antenna 1 of a base station includes a radome 11. The radome 11 has a good electromagnetic wave penetration characteristic in terms of an electrical property, and is able to withstand impact of a harsh external environment in terms of mechanical performance, so that an antenna system is protected from the impact of the external environment. The antenna 1 is mounted on the pole 2 or an iron tower with the antenna adjustment support 3, to facilitate receiving or transmitting of signals of the antenna 1.

In addition, the base station further includes a radio frequency processing unit 5 and a baseband processing unit 6. For example, the radio frequency processing unit 5 is configured to perform frequency selection, amplification, and down-conversion processing on a signal received by the antenna 1, convert the signal into an intermediate frequency signal or a baseband signal, and send the intermediate frequency signal or the baseband signal to the baseband processing unit 6. Alternatively, the radio frequency processing unit 5 is configured to perform up-conversion and amplification processing on a baseband signal” or an intermediate frequency signal, and convert the baseband signal or the intermediate frequency signal into an electromagnetic wave by using the antenna 1, and send the electromagnetic wave out. The baseband processing unit 6 is connected to a feeder network of the antenna 1 via the radio frequency processing unit 5. In some implementations, the radio frequency processing unit 5 is also referred to as a remote radio unit (remote radio unit, RRU), and the baseband processing unit 6 is also referred to as a baseband unit (baseband unit, BBU).

In at least one embodiment, as shown in FIG. 2, the radio frequency processing unit 5 is integrated with the antenna 1, and the baseband processing unit 6 is located at a remote end of the antenna 1. In some other embodiments, both the radio frequency processing unit 5 and the baseband processing unit 6 are alternatively located at the remote end of the antenna 1. The radio frequency processing unit 5 and the baseband processing unit 6 are connected through a cable 7.

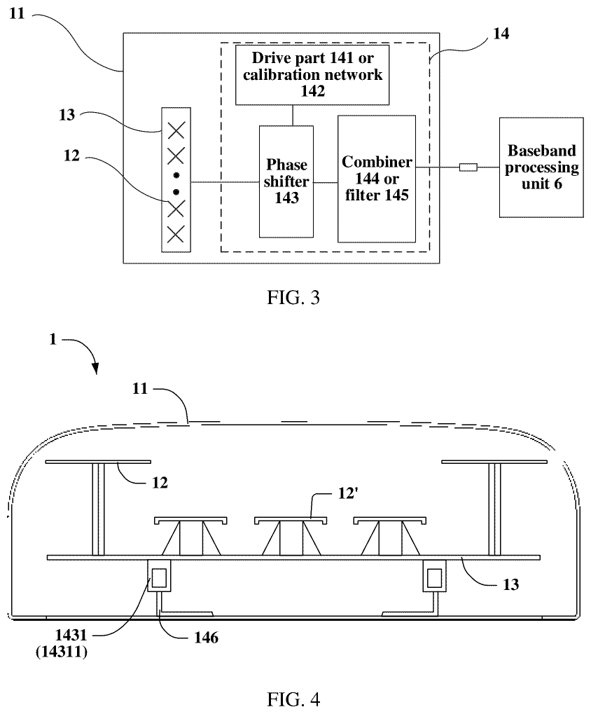

More specifically, refer to FIG. 2 and FIG. 3 together. FIG. 3 is a schematic diagram of composition of an antenna according to at least one embodiment. As shown in FIG. 3, an antenna 1 of a base station includes a first radiation element 12 and a reflection plate 13. The first radiation element herein generally refers to all radiation elements. The foregoing “first” does not impose any limitation on a feature of the radiation element. For example, a first radiation element 12, a second radiation element 12′, and the like described in the following embodiments is included. The first radiation element 12 is also referred to as an antenna element, an element, or the like. The first radiation element 12 is an element that forms a basic structure of an antenna array, and effectively sends or receives an antenna signal. In the antenna 1, frequencies of different first radiation elements 12 are the same or different. The reflection plate 13 is also referred to as a bottom plate, an antenna panel, a reflection surface, or the like, and is specifically made of a metal material. In response to the antenna receiving a signal, the reflection plate 13 reflecting the antenna signal and aggregate the antenna signal on a receiving point, to implement directional reception. In response to the antenna transmitting a signal, the reflection plate 13 implements directional transmission of the antenna signal. The first radiation element 12 is usually disposed on a surface on one side of the reflection plate 13, so that a signal receiving or transmitting capability of the antenna 1 is greatly enhanced, and interference of another electromagnetic wave from a back side of the reflection plate 13 (in at least one embodiment, the back side of the reflection plate 13 refers to a side opposite to the side that is of the reflection plate 13 and on which the first radiation element 12 is disposed) on antenna signal receiving is also blocked and shielded, thereby improving a gain of the antenna.

In the antenna 1 of the base station, the first radiation element 12 is connected to a feeder network 14. The feeder network 14 is usually formed by a controlled impedance transmission line. The feeder network 14 feeds a signal to the first radiation element 12 according to a specific amplitude and phase, or sends a received signal to the baseband processing unit 6 of the base station according to a specific amplitude and phase. Specifically, in some implementations, the feeder network 14 implements different radiation beam directivity by using a drive part 141, or is connected to a calibration network 142 to obtain a calibration signal used by the system. The feeder network 14 includes a phase shifter 143, configured to change a maximum direction of antenna signal radiation. Some modules for performance extension are further disposed in the feeder network 14, for example, a combiner 144 that is configured to combine signals of different frequencies into one signal and transmit the signal through the antenna 1. Alternatively, in response to being used in reverse, the combiner 144 is configured to divide a signal received by the antenna 1 into a plurality of signals based on different frequencies and transmit the signals to the baseband processing unit 6 for processing. For another example, the module is a filter 145 configured to filter out an interference signal.

FIG. 4 is a side sectional view of an antenna according to at least one embodiment. As shown in FIG. 4, an antenna 1 includes a first phase shifter 1431, a first radiation element 12, a second radiation element 12′, and a mounting structure 146. The first phase shifter 1431 includes a cavity 14311 and a phase-shift circuit (not shown in the figure). Specifically, one first phase shifter 1431 includes one or more cavities 14311. For example, in response to the first radiation element 12 being a dual-polarized radiation element, the first phase shifter 1431 includes two cavities 14311 that are configured to correspondingly connect to a column of first radiation elements 12. In all the accompanying drawings of at least one embodiment, an example in which there is one cavity is used. The cavity 14311 is a cavity 14311 that has a closed cross section, or is a cavity 14311 that has a non-closed cross section. The cavity 14311 is configured to form a ground layer of the phase-shift circuit of the first phase shifter 1431. The phase-shift circuit is disposed in the cavity 14311, and a specific disposing position of the phase-shift circuit is not limited. For example, in response to the cavity being the cavity that has the closed cross section, the phase-shift circuit is disposed inside the cavity 14311, or is disposed on an outer surface of the cavity 14311. The cavity 14311 is connected to the mounting structure 146, and the mounting structure 146 is configured to mount the antenna 1 on a pole or an iron tower of a base station. The first radiation element 12 and the second radiation element 12′ are configured to send and receive an antenna signal. In this solution, the antenna 1 is mounted by using the cavity 14311 of the first phase shifter 1431. The cavity 14311 is used as a frame of the antenna 1, and supports the entire antenna 1 and transmits force born by the antenna 1 to the pole or the iron tower. Because rigidity of the cavity 14311 is large, the cavity 14311 of the first phase shifter 1431 is used as a force-bearing framework of the antenna 1, and the cavity 14311 is used to bear a weight of the antenna 1, to help improve stability of the mounting structure of the antenna 1, so that the antenna 1 is not prone to damage, a service life of the antenna 1 is prolonged, and performance of the antenna 1 of the base station is ensured.

In this embodiment, there are one or more first phase shifters 1431. In response to the first phase shifter 1431 being specifically disposed, phase-shift circuits correspondingly disposed in cavities 14311 of different first phase shifters 1431 have a same frequency band, or have different frequency bands. This is not limited in at least one embodiment. A type of a first radiation element 12 connected to each cavity 14311 is not limited. For example, the first radiation element 12 is a die-casting first radiation element 12, a sheet metal first radiation element 12, a printed circuit board first radiation element 12, a plastic first radiation element 12, or an electroplated first radiation element 12.

In a specific technical solution, the cavity 14311 is prepared by using a profile. The profile is used as the cavity 14311, to help improve strength of the cavity 14311, and also help reduce a weight of the cavity 14311. In addition, a preparation process of the cavity 14311 is able to be further simplified and costs are reduced.

A shape of the cavity 14311 of the first phase shifter 1431 is not limited, and is specifically a block shape, or is a strip shape or an irregular shape, provided that the shape is designed based on a specific structure and a layout of the antenna 1.

Still refer to FIG. 4. In a specific embodiment, the antenna 1 further includes a reflection plate 13, where the reflection plate 13 is specifically a plate shape. The reflection plate 13 is connected to the cavity 14311. Strength of the reflection plate 13 is usually weak. Therefore, in this solution, the reflection plate 13 is not used to bear all the weight of the antenna 1, so that a service life of the reflection plate 13 is prolonged, the reflection plate 13 is less likely to be cracked or damaged during mechanical reliability testing or use, and crack of a welding spot that is disposed on the reflection plate 13 is less prone to occur, thereby prolonging the service life of the antenna 1.

In a specific embodiment, a connection manner between the reflection plate 13 and the cavity 14311 is not limited. For example, the reflection plate 13 and the cavity 14311 is connected via a welding, riveting, or screw connection. Alternatively, the reflection plate 13 and the cavity 14311 is an integrally formed structure. In addition, a position of the cavity 14311 on the reflection plate 13 is not limited, and is located at any position such as an edge or a middle of the reflection plate 13.

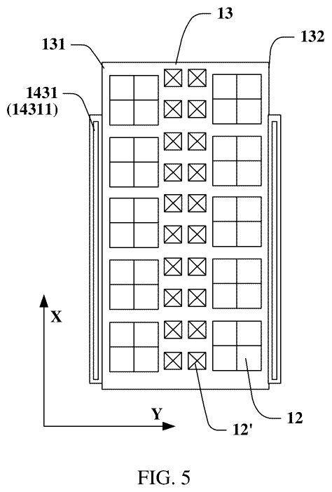

FIG. 5 is a top view of an interior of an antenna according to at least one embodiment. Refer to FIG. 5. A length of the reflection plate 13 in a first direction X is greater than a length in a second direction Y, and the first direction X is perpendicular to the second direction Y. In a specific embodiment, the reflection plate 13 is a rectangle, or certainly is of another shape. This is not limited in at least one embodiment. In response to the reflection plate 13 being of another shape, a longer direction of the reflection plate 13 is selected as the first direction X, and a shorter direction is selected as the second direction Y. For example, in response to the reflection plate 13 being a trapezoid, an extension direction of a bottom edge of the trapezoid is the first direction X of the reflection plate 13, and a direction that is perpendicular to the bottom edge of the trapezoid is the second direction Y. Alternatively, a direction in which a length is the longest of the reflection plate 13 is the first direction X, and a direction that is perpendicular to the first direction X is the second direction Y. In an implementation, in response to the cavity 14311 of the first phase shifter 1431 being a strip cavity 14311, the strip cavity 14311 extends in the first direction X. Strength of the reflection plate 13 is poorer in a direction in which a length is greater. Therefore, the strip cavity 14311 is fastened to the reflection plate 13 in the first direction X of the reflection plate 13, so that the strength of the reflection plate 13 is improved to a large extent.

Still refer to FIG. 5. The reflection plate 13 includes a first side edge 131 and a second side edge 132 that are opposite to each other, in other words, the first side edge 131 and the second side edge 132 are separately two edges of the reflection plate 13. The first side edge 131 and the second side edge 132 extend in the first direction X, and the first side edge 131 and the second side edge 132 are separately connected to the strip cavity 14311. In some application scenarios, a circuit pattern is made on the reflection plate 13, for example, in an application scenario in which the reflection plate 13 is a reflection lens plate, the reflection plate 13 has the circuit pattern. In at least one embodiment, the cavity 14311 is disposed at an edge of the reflection plate 13, to enable the cavity 14311 to avoid the circuit pattern, and reduce impact of the cavity 14311 on a working status of the reflection plate 13. In addition, the cavity 14311 is located at the edge of the reflection plate 13, to help avoid a radiation signal generated by the antenna and reduce an insertion loss of the antenna, and help improve a gain of the antenna.

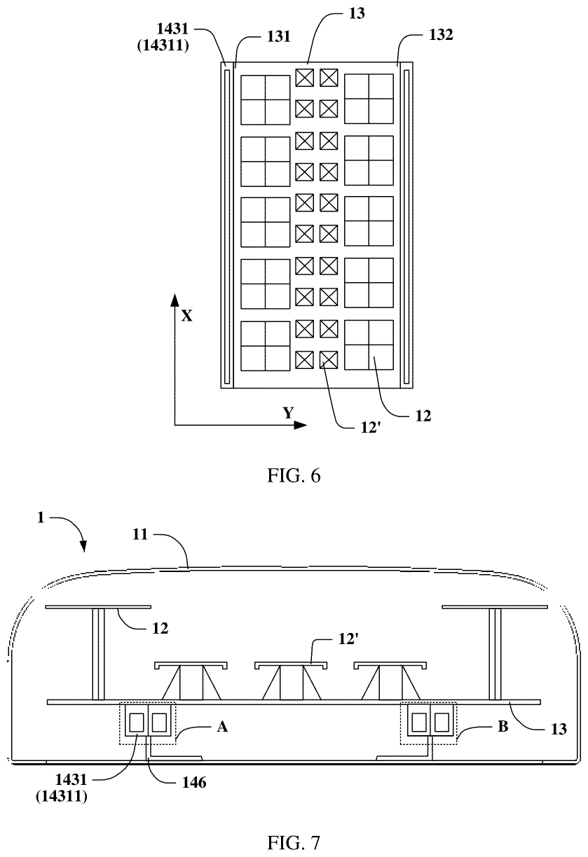

FIG. 6 is a top view of an interior of an antenna according to at least one embodiment. As shown in FIG. 6, a length of the strip cavity 14311 in the first direction X is equal to the length of the reflection plate 13 in the first direction X. In this solution, the strip cavity 14311 provides comprehensive support for the reflection plate 13, to improve strength of the frame of the antenna 1. In addition, a structure of the antenna 1 is normalized.

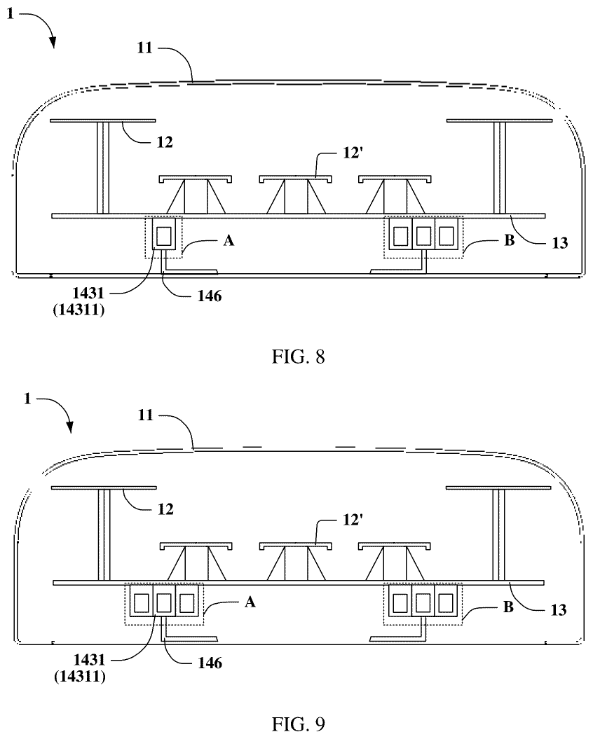

FIG. 7 is a schematic diagram of a structure of an antenna according to at least one embodiment. As shown in FIG. 7, in an embodiment, the antenna 1 includes at least two first phase shifters 1431, and the at least two first phase shifters 1431 are divided into two groups. The two groups of first phase shifters 1431 are separately a first group A of first phase shifters and a second group B of first phase shifters. A quantity of first phase shifters 1431 included in the first group A of first phase shifters is the same as or different from a quantity of first phase shifters 1431 included in the second group B of first phase shifters. This is not limited in at least one embodiment. For example, the antenna 1 includes four first phase shifters 1431. In the embodiment shown in FIG. 7, the four first phase shifters 1431 are evenly divided into two groups, to be specific, the first group A of first phase shifters and the second group B of first phase shifters separately include two first phase shifters 1431. Alternatively, FIG. 8 is a schematic diagram of a structure of an antenna according to at least one embodiment. In the embodiment shown in FIG. 8, a quantity of first phase shifters 1431 included in the first group A of first phase shifters is different from a quantity of first phase shifters 1431 included in the second group B of first phase shifters. Specifically, the first group A of first phase shifters includes one first phase shifter 1431, and the second group B of first phase shifters includes three first phase shifters 1431.

Specifically, a cavity 14311 in each group of first phase shifters 1431 is fixedly of an integrated structure. For example, in response to a group of cavities including three cavities 14311, the three cavities 14311 are fixedly of an integrated structure. This solution helps improve strength of the cavity 14311 as a frame. A specific fastening manner of each group of cavities 14311 is not limited. For example, all cavities 14311 in each group of cavities 14311 is an integrally formed structure, or all the cavities 14311 in each group of cavities 14311 is fixedly of an integrated structure in a manner of welding, riveting, screw connection, or the like.

FIG. 9 is a schematic diagram of a structure of an antenna according to at least one embodiment. As shown in FIG. 9, a quantity of first phase shifters 1431 included in the antenna 1 is not limited. In response to the quantity of first phase shifters 1431 being an even number, the even number of first phase shifters 1431 are symmetrically disposed on the reflection plate 13. For example, the quantity of first phase shifters 1431 is two, four, or six. In the embodiment shown in FIG. 9, the quantity of first phase shifters 1431 is six. In response to the first phase shifters 1431 being divided into two groups, each group includes three first phase shifters 1431, and a cavity 14311 in each group of first phase shifters 1431 is specifically fixedly of an integrated structure. In addition, the two groups of first phase shifters 1431 are symmetrically disposed on the reflection plate 13. In another embodiment, as shown in FIG. 4, in response to the quantity of first phase shifters 1431 being two, the first phase shifters 1431 is divided into two groups, each group includes one first phase shifter 1431, and the two groups of first phase shifters 1431 are symmetrically disposed on the reflection plate 13. Alternatively, as shown in FIG. 7, in response to the quantity of first phase shifters 1431 being four, the first phase shifters 1431 is divided into two groups, each group includes two first phase shifters 1431, and the two groups of first phase shifters 1431 are symmetrically disposed on the reflection plate 13. The foregoing symmetrical disposing helps improve symmetry of a structure formed by the cavity 14311 and the reflection plate 13, and helps improve uniformity of force born by the antenna 1, so that strength of the antenna 1 is strong.

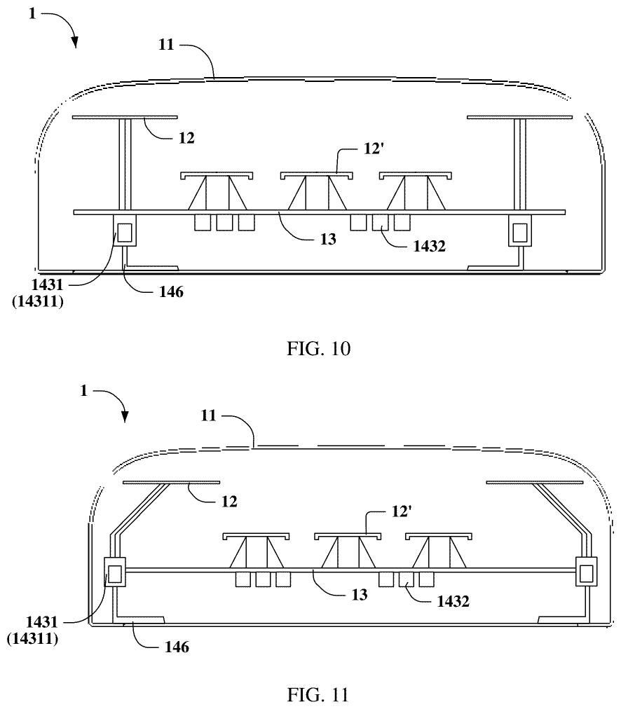

FIG. 10 is a schematic diagram of a structure of an antenna according to at least one embodiment. FIG. 11 is a schematic diagram of a structure of an antenna according to at least one embodiment. A cavity 14311 in the embodiment shown in FIG. 10 is not located at an edge of a reflection plate 13, but is disposed closer to a center of the reflection plate rather than the edge of the reflection plate 13. A cavity 14311 in the embodiment shown in FIG. 11 is located at two edges on two sides of the reflection plate 13. As shown in FIG. 10 and FIG. 11, in a specific embodiment, the foregoing antenna 1 further includes a first radiation element 12. The first radiation element 12 is fastened to the cavity 14311, and the first radiation element 12 is connected to a phase-shift circuit in the cavity 14311 of a first phase shifter 1431. In this embodiment, the first radiation element 12 is fastened to the cavity 14311, and the first radiation element 12 is not disposed on the reflection plate 13. In this solution, the cavity 14311 is used to bear a weight of the first radiation element 12, and the reflection plate 13 does not bear either a weight of the first phase shifter 1431 or the weight of the first radiation element 12. Therefore, this solution reduces a weight born by the reflection plate 13, reduces a probability of damage to the reflection plate 13, and improves overall reliability of the antenna 1. The first radiation element 12 is directly connected to the phase-shift circuit in the first phase shifter 1431, and a connection path is short, to reduce adapter parts such as a cable for connecting the first radiation element 12 to the first phase shifter 1431, so as to reduce a loss of the connection path and improve gain performance of the antenna 1. In addition, this solution also reduces manufacturing hours.

Still refer to FIG. 10. The foregoing first radiation element 12 is specifically a first radiation element 12 in FIG. 10. In addition, the antenna 1 further includes a second radiation element 12′, and the second radiation element 12′ is fastened to the reflection plate 13. In a specific embodiment, the weight of the first radiation element is greater than a weight of the second radiation element 12′. A first radiation element 12 with the larger weight is fastened to the cavity 14311 of the first phase shifter 1431, and the cavity 14311 is used to bear the weight of the first radiation element 12, so that the weight born by the reflection plate 13 is further reduced.

Specifically, in response to the first phase shifter 1431 and the first radiation element 12 being disposed, the first phase shifter 1431 and the first radiation element 12 are disposed on two sides of the reflection plate 13. Certainly, the first phase shifter 1431 and the first radiation element 12 are alternatively disposed on a same side of the reflection plate 13. This is not limited in at least one embodiment.

Still refer to FIG. 10 and FIG. 11. In FIG. 11, because this solution enables the first phase shifter 1431 and the first radiation element 12 not to occupy space of a surface of the reflection plate 13, the space of the reflection plate 13 is robust. In FIG. 10 and FIG. 11, the foregoing antenna 1 further includes a second phase shifter 1432. Specifically, the second phase shifter 1432 is connected to the second radiation element 12′. Specifically, in response to the second phase shifter 1432 being disposed, the second phase shifter 1432 is flatly disposed on the surface of the reflection plate 13. In other words, the second phase shifter 1432 is not disposed in a stacked manner, to help reduce thickness of the antenna 1 and improve wind load and size competitiveness of the antenna 1. In addition, an additional structure such as a drive part is further disposed on the reflection plate 13, or the additional structure is alternatively disposed in the cavity 14311. This is not limited in at least one embodiment.

The second phase shifter 1432 is specifically smaller than the first phase shifter 1431. In other words, in the phase shifters of the antenna 1, a first phase shifter 1431 with a larger size is used as a frame, and is connected to the reflection plate 13 and a mounting structure 146. The first phase shifter 1431 with the larger size has a better supporting effect, and the second phase shifter 1432 with a smaller size has a smaller weight, so that the reflection plate 13 bears a smaller weight. In a specific embodiment, the second phase shifter 1432 is connected to the second radiation element 12′.

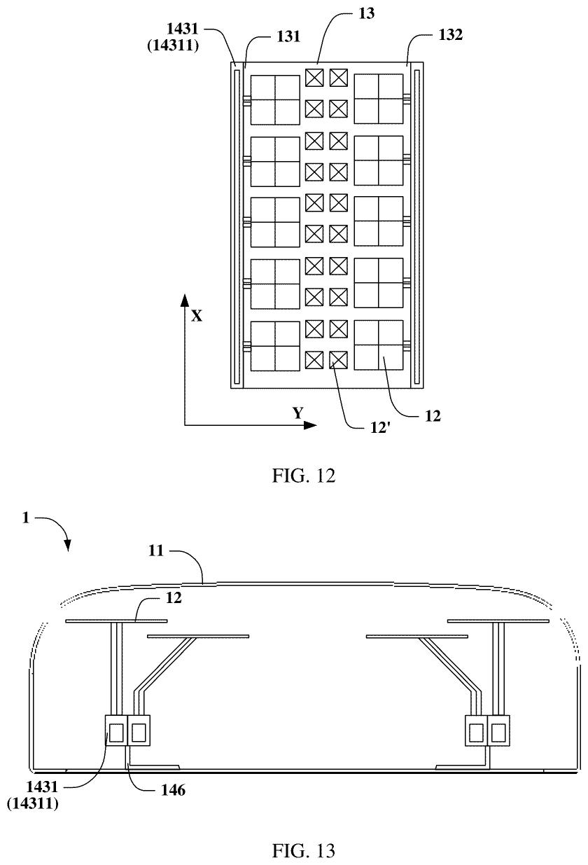

FIG. 12 is a schematic diagram of a structure of an interior of an antenna according to at least one embodiment. As shown in FIG. 12, the foregoing cavity 14311 is specifically a strip cavity 14311. The antenna 1 includes a plurality of first radiation elements 12, and the plurality of first radiation elements 12 are arranged in a straight line to form a linear array antenna system. An extension direction of the strip cavity 14311 is consistent with an extension direction of the linear array antenna system, so that each first radiation element 12 is connected to the strip cavity 14311. In addition, a length of the strip cavity 14311 in the extension direction is greater than or equal to a length of the linear array antenna system in the extension direction. In this solution, all first radiation elements 12 of one linear array antenna system are disposed in one strip cavity 14311.

FIG. 13 is a schematic diagram of a structure of an antenna according to at least one embodiment. As shown in FIG. 13, in another embodiment, the antenna 1 further includes a radome 11 and a first radiation element 12, and a first phase shifter 1431 and the first radiation element 12 are disposed in the radome 11. The first radiation element 12 is fastened to a cavity 14311 of the first phase shifter 1431, and is electrically connected to a phase-shift circuit. An inner wall of the radome 11 has a reflection layer, and the reflection layer is specifically a reflection coating. A preparation process of the reflection coating is simple and costs are low. In this solution, first radiation elements 12 are all disposed in the cavity 14311 of the first phase shifter 1431. In addition, another additional part is also disposed in the cavity 14311. In this solution, no additional reflection plate 13 is to be disposed, so that costs are low.

In this embodiment, the cavity 14311 is also a strip cavity 14311, the antenna 1 includes a plurality of first radiation elements 12, and the plurality of first radiation elements 12 are arranged in a straight line to form a linear array antenna system. An extension direction of the strip cavity 14311 is consistent with an extension direction of the linear array antenna system, so that each first radiation element 12 is connected to the strip cavity 14311. In addition, a length of the strip cavity 14311 in the extension direction is greater than or equal to a length of the linear array antenna system in the extension direction. In this solution, all first radiation elements 12 of one linear array antenna system are disposed in one strip cavity 14311, so that the strip cavity 14311 is used to carry the linear array antenna system, to improve integrity of the antenna 1.

A person skilled in the art is able to make various modifications and variations to at least one embodiment without departing from the protection scope of embodiments described herein. At least one embodiment is intended to cover these modifications and variations provided that they fall within the scope of protection defined by the following claims and their equivalent technologies.

What is claimed is:

1. An antenna, comprising a first phase shifter, wherein the first phase shifter comprises a cavity and a phase-shift circuit, the phase-shift circuit is disposed in the cavity, the cavity is connected to a mounting structure, and the mounting structure is connected to a pole.

2. The antenna according to claim 1, further comprising a reflection plate, wherein the reflection plate is connected to the cavity.

3. The antenna according to claim 2, wherein the cavity is a strip cavity, the reflection plate extends in a first direction and a second direction separately, the first direction is perpendicular to the second direction, and a length of the reflection plate in the first direction is greater than a length of the reflection plate in the second direction; and the strip cavity extends in the first direction.

4. The antenna according to claim 3, wherein the reflection plate comprises a first side edge and a second side edge that are opposite to each other, the first side edge and the second side edge extend in the first direction, and the first side edge and the second side edge are separately connected to the strip cavity.

5. The antenna according to claim 3, wherein a length of the strip cavity in the first direction is equal to the length of the reflection plate in the first direction.

6. The antenna according to claim 2, wherein a quantity of first phase shifters is an even number, and the even number of first phase shifters are symmetrically disposed on the reflection plate.

7. The antenna according to claim 2, wherein the antenna further comprises a second phase shifter, and the second phase shifter is flatly disposed on a surface of the reflection plate.

8. The antenna according to claim 1, wherein the antenna further comprises a radiation element, and the radiation element is connected to the cavity.

9. The antenna according to claim 1, wherein the antenna further comprises a radome and a radiation element, the first phase shifter and the radiation element are disposed in the radome, and an inner wall of the radome has a reflection layer; and the radiation element is connected to the cavity.

10. The antenna according to claim 8, wherein the cavity is the strip cavity, and a plurality of radiation elements form a linear array antenna system; and an extension direction of the strip cavity is consistent with an extension direction of the linear array antenna system.

11. The antenna according to claim 10, wherein a length of the strip cavity in the extension direction is greater than or equal to a length of the linear array antenna system in the extension direction.

12. The antenna according to claim 1, comprising at least two first phase shifters, wherein the at least two first phase shifters are divided into two groups, and a cavity in each group of first phase shifters is of an integrated structure.

13. A base station antenna feeder system, comprising an antenna and a pole, wherein the antenna comprises a first phase shifter, wherein the first phase shifter comprises a cavity and a phase-shift circuit, the phase-shift circuit is disposed in the cavity, the cavity is connected to a mounting structure, and the mounting structure is connected to the pole.

14. The base station antenna feeder system according to claim 1, wherein the antenna further comprises a reflection plate, wherein the reflection plate is connected to the cavity.

15. The base station antenna feeder system according to claim 2, wherein the cavity is a strip cavity, the reflection plate extends in a first direction and a second direction separately, the first direction is perpendicular to the second direction, and a length of the reflection plate in the first direction is greater than a length of the reflection plate in the second direction; and the strip cavity extends in the first direction.

16. The base station antenna feeder system according to claim 3, wherein the reflection plate comprises a first side edge and a second side edge that are opposite to each other, the first side edge and the second side edge extend in the first direction, and the first side edge and the second side edge are separately connected to the strip cavity.

17. The base station antenna feeder system according to claim 3, wherein a length of the strip cavity in the first direction is equal to the length of the reflection plate in the first direction.

18. The base station antenna feeder system according to claim 2, wherein a quantity of first phase shifters is an even number, and the even number of first phase shifters are symmetrically disposed on the reflection plate.

19. The base station antenna feeder system according to claim 2, wherein the antenna further comprises a second phase shifter, and the second phase shifter is flatly disposed on a surface of the reflection plate.

20. The base station antenna feeder system according to claim 1, wherein the antenna further comprises a radiation element, and the radiation element is connected to the cavity.
